(19) United States
(12) Patent Application Publication
(10) Pub. No.: US 2006/0140365 A1
(43) Pub. Date: Jun. 29, 2006

(54) System processing information on subjects of business activity

(76) Inventor: Vitaly Mikhailovich Zanin, Vladivostok (RU)

Correspondence Address: Andrey Ermolinsky, P O Box 35-94, Vladivostok, 690035, RU

(21) Appl. No.: 10/543,852

(22) PCT Filed: Feb. 2, 2004
(86) PCT No.: PCT/RU04/00033

§ 371 Date: Jul. 28, 2005

(30) Foreign Application Priority Data
Feb. 3, 2003 (RU) 2003102787

(51) Int. Cl. H04M 11/00

(52) U.S. Cl. 379/93.12

(57) ABSTRACT

The invention relates to information retrieval network systems and can be used for processing information documents on goods and services of subjects of business activity stored in the memory (5) of a centralized server (1), for retrieving and dispatching the said documents with the aid of remote devices of users (6, 7, 8, 9, 11). Telephones (6) and faxes (7) must operate in a tone mode. A table (10) and loud speakers (12) are stationary or movably arranged on a place of concentration of potential users. The inventive system also comprises material advertising carriers of the subjects whose documents are stored in the memory (5). The said advertising carriers contain information on a unique number of subject documents assigned by the server (1) and on the method for connecting the said server (1).

### TECHNICAL FIELD

The invention relates to information retrieval network systems and may be used for processing information documents of subjects of business activity stored on a centralized server, for retrieving and dispatching the said documents to remote users.

### BACKGROUND ART

There are known information systems intended for storing, processing and transmitting information documents as facsimile images (faxes) as inquired by a user.

There is a known interactive system for information retrieval of faxes [U.S. Pat. No. 5,068,888, 1991]. The system automatically delivers documents from the central information storage device to a emote fax in response to a user's inquiry. The information delivery system includes expanded memory to store files of images of documents in digital form. The inquiry processing module automatically receives telephone inquiries on certain stored documents, produces signals, which prompt a telephoning person what information should be input to deliver selected documents. Information of the order includes at the least a code of identification of documents selected for delivery and the user's fax numbers. At least one module of delivery of faxes provides automatic delivery of selected documents to the user's fax.

There is a known telephone network with extended capabilities with an image-allocation system [U.S. Pat. No. 5,200,993, 1993]. The image system is linked to end users through bridges, routers and gateways adapted for this purpose, which provide the user with access to the virtual local network. Automatic number information is used by number for automatic selection of the system configuration as required by the user. The central processing system fulfills actions with texts and images and their transmission, for example, facsimile transmission by using switching network facilities.

There is a known facsimile server system that may be used as independent fax [U.S. Pat. No. 5,552,901, 1996]. A remote fax includes a scanner, printer and facsimile module of communication. The client supplies data of the document to the facsimile server and makes an inquiry of facsimile transmission or printing. The facsimile server expands data of the document to be transmitted, to data of image and transmits data of such image to a relevant remote fax by giving a command for facsimile transmission. The facsimile server has the capability to accumulate data of images and propose them to the client during retrieval.

With the advance of telecommunication networks, the Internet in particular, facsimile systems are displaced by the Internet systems, for example, by “retrieving machines” providing the user with more convenient and rapid retrieval and delivery of necessary documents, as well as additional retrieval capabilities.

Thus, there is a known system for processing information on subjects of business activity in the Internet for personalized use “TRADEVISA”, which includes subscribers' remote devices as computers and/or servers and server device or devices for reception, processing, storage and issue of information documents of subjects of business activity including characteristics of business activity [RU 26267 U1, 2002]. Subscribers' devices has the capability to transmit documents to the server device, change and delete such documents, retrieve documents by inquiry stored on the server device. The system also contains advertising material carriers of subjects of business activity whose documents are stored on the server device, the said advertising material carriers are not material carriers of the server device; at that, the advertising material carrier of a certain subject of business activity has information on its unique document number assigned by the server device, and commercial designation and/or domain name of the server device, and subscribers' devices can retrieve the documents by the said unique numbers. Advertising material carriers may be made as magnetic carriers and/or paper mass media, and/or outdoor advertising and/or visiting cards.

However, retrieving machines may not be used by users, which do not have entrance to the Internet. In this connection, within the recent years there have been systems for processing information, which combine the Internet service with “traditional” such as delivery of facsimile messages.

A communication network with the base of information data of information documents on goods and other advertising information is chosen as a progenitor [DE 19643166, 1998; DE 19723479, 1998]. The data base is contained in the central server memory, which is connected through the network to many various client external devices, for example, to fax, personal computer with the aid of a modem, to digital television network with the aid of a decoder. The server automatically retrieves required information in response to the client's certain inquiry.

The said system has limited capabilities since it gives no way of rather quickly finding a required information document, when it is well know that the document is related to a certain subject and stored on the server device.

### DISCLOSURE OF THE INVENTION

The technical problem to be solved is to expand functional capabilities of the systems for retrieving the required commercial information stored on a certain server of the telecommunication network.

It is proposed the system for processing information on subjects of business activity in the telecommunication system for personalized use, which includes a centralized server that through the telecommunication network with the aid of modems and/or fax-modems, and/or decoders is connected to many remote devices of users; as this takes place, the centralized server includes a memory device for storing information documents of users, subjects of business activity on goods and/or services to be sold by them, as well as a processor for processing such information documents, and subscribers' remote devices can display text, graphic, sound information, and includes telephones and/or facsimile devices, which can operate in a tone mode, and personal computers with peripheral devices, which can reproduce and/or display the information documents or their parts. The new thing is that the system additionally contains advertising material carriers of subjects of business activity whose information documents are stored in the memory device, as this takes place, the advertising material carrier of a certain subject of business activity has information on unique number of the information document of such subject in the system assigned by the centralized server (automatically or by administrator), and on the method of communication with the centralized server through the communication network, and users' remote devices can retrieve the information documents by the unique numbers, in so doing, users' telephones and/or facsimile devices can operate in a tone mode.

Advertising material carriers may be made as magnetic carriers and/or paper mass media, and/or outdoor advertising (as an example, boards, signs etc., and/or visiting cards and/or booklets, and/or advertising handbills).

The remote personal computer peripheral device may be made as: a) light table, which has the capability to display an information document or its part in text or graphic form; b) loudspeaker, which has the capability to reproduce an information document or its part in sound form. Such peripheral devices are stationary or movably arranged on places of concentration of potential users of goods and/or services.

The system may have the capability of retrieving and selecting a required information document or its part by the user with the aid of a dial of the telephone and/or facsimile device operating in a tone mode, with the use of a certain order of dial-up of signals of a dial of the telephone and facsimile device by the user after establishing communication with the centralized server; as this takes place, the system additionally includes advertising material carriers of the system, which at the least have information on the method of communication with the centralized server through the telephone network and said order of dial-up of signals.

In so doing, the system may be made with the capability to:

reproduce a selected information document or its part with the aid of sound by sound reproduction device of the user's telephone and/or facsimile device;

display a selected information document or its parts as image on the facsimile device's paper carrier.

As this takes place, advertising material carriers of the system itself may be made as magnetic carriers and/or paper mass media and/or carriers of outdoor advertising, and/or visiting cards and/or booklets and/or advertising handbills.

As this takes place, the order of dial-up of signals may correspond to the unique number of a certain subject's information document.

In doing so, the system may be made with the capability to reproduce the information document of a previously known subject or a part of such document with the aid of sound by sound reproduction device of the telephone and/or facsimile device within intervals when the user dials up signals of the dial.

### BRIEF DESCRIPTION OF THE FIGURES ON THE DRAWINGS

FIG. 1 gives the general view of the commercial information retrieval system “Business Fax” where arrows illustrate directions of information flows.

FIG. 2 illustrates a fragment of advertising handbill of the system with information on categories of retrieval of the information document by dial keys of the telephone or facsimile device as well as on the method of communication the system.

### THE EXAMPLE FOR CARRYING OUT THE INVENTION

The invention is explained by the example of the commercial information retrieval system “Business Fax” now in operation, which is available for the users at +7 (4232) 51-51-51 or through the Internet at www.bf51.info.

The system “Business Fax” is intended for retrieval by the users of enterprises and businessmen and information on goods and/or services (works) produced and rendered by them.

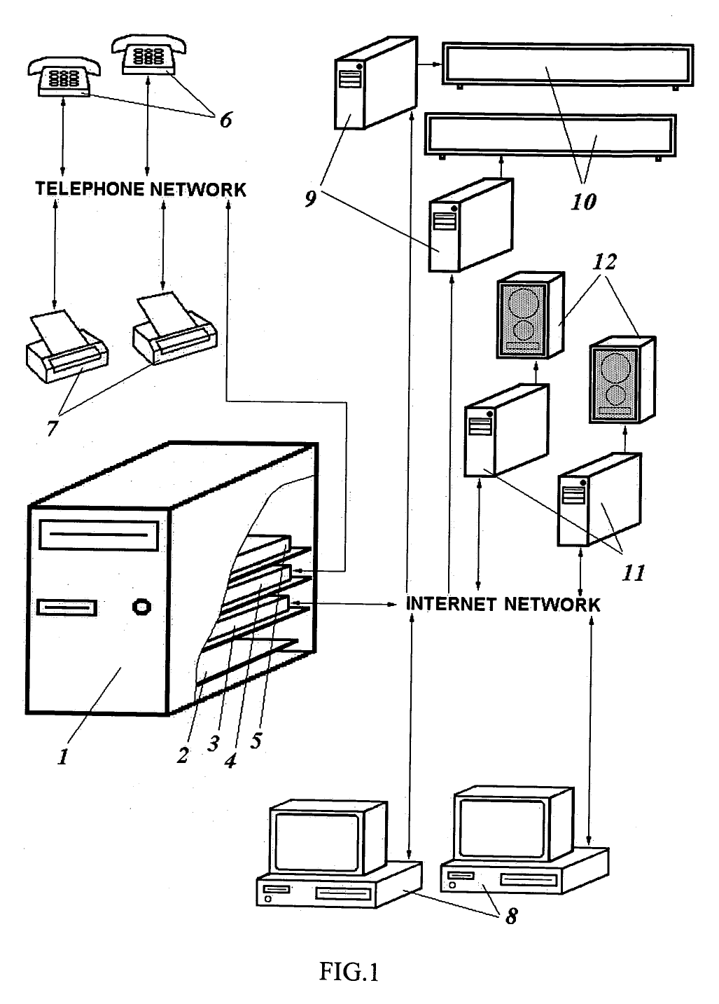

The system includes (see FIG. 1) centralized server 1, which in particular contains processor 2 on the basis of processor Intel Pentium-4, US Robotics modem 3 at a speed of 50 kB/sec, VFXD/41E fax-voice board for 4 channels, memory device 5 as hard disc, which is capable of storing a scope of information necessary for normal operation of the system. Server 1 is equipped with relevant software, which is not the object of protection within this technical decision. The system also includes the following remote devices of the users connected to server 1 through the telephone network or the Internet: telephones 6; facsimile devices 7 (hereinafter referred to as the faxes); personal computers 8 with monitors; computers 9 connected to light tables 10; computers 11 connected to loudspeakers 12. Telephones 6 and faxes 7 should have the capability to operate in a tone mode. Table 10 and loudspeakers 12 are stationary or movably arranged on places of concentration of potential users of goods and/or services, i.e. in shops, markets and so forth. The system also contains advertising material carriers (not shown) of a part of users being clients of the system, and information documents with a list of goods and/or services stored in memory device 5. The following may be used as material carriers: hard and floppy discs of computers, outdoor boards, signs, visiting cards; booklets, advertising handbills, magazines and newspapers with advertising information, which includes name of an enterprise, its unique number in the system “Business Fax”, the above said address in the Internet and/or telephone number for communication with the system.

The operation of the system includes registration of clients, subjects of business activity (enterprises, businessmen) and retrieval of data on registered clients by the user's inquiries being potential users of clients' goods and/or services. The client's information document is stored in memory device 5 by assigning the unique number to it, which is called the number of virtual office of the system “Business Fax”.

Retrieval and reception of the required information document stored in memory device 5 may be carried out by the user by several methods.

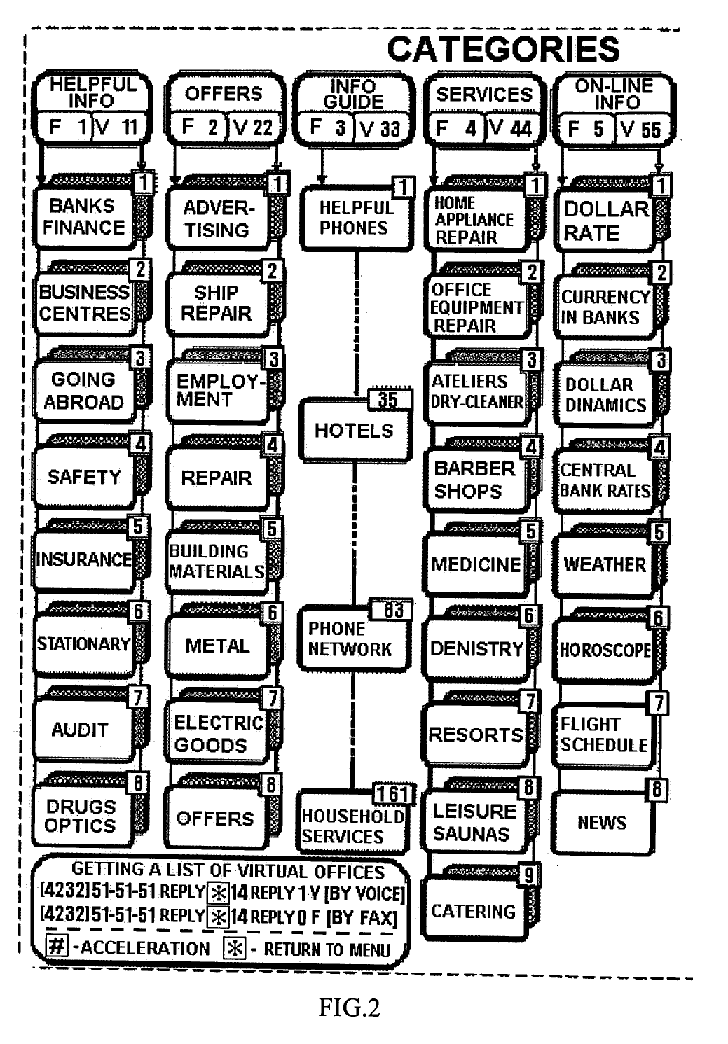

By inquiry from remote computer 8 the user may receive the information document and put it to any peripheral device of computer 8, for example, a monitor, printer and so forth. From telephone 6 the user retrieves as follows. The user takes telephone 6 to a tone mode and dials up a telephone number for communication with the system, after connecting to server 1 through board 4 the user can retrieve and select the required information document in various categories with the aid of a dial by using certain keys and order of their dial up, which may be arranged on advertising material carriers of the server owner (see FIG. 2). After finding the required information document the user receives the information document from server 1 to its telephone 6 as sound file.

Retrieval with the aid of fax 7 is carried out in a similar way, expect that the found information document may be received by the user both as sound file and as image of the document printed by fax 7. In intervals when the user dials up signals of the dial the system may carry out sound reproduction of the information documents of registered clients, which ordered such advertising service to be rendered (in the same manner as “running line”).

The information document of a specific enterprise or businessman may be received by the user rather quickly, by inputting during retrieval in the system the numbers of a virtual office of this enterprise or businessman previously found out by the user in advertising material carriers, for example, with the aid of a telephone dial.

Clients' information documents are distributed among potential users by their inquiry or without such in sound or visual form with the aid of table 10 and external loudspeakers 17, and in the form of images—by their dispatch to faxes 7.

1. The system for processing information on subjects of business activity in the telecommunication network for personalized use, which includes a centralized server that through the telecommunication network with the aid of modems and/or fax-modems, and/or decoders is connected to many remote devices of users; as this takes place, the centralized server includes a memory device for storing information documents of users, subjects of business activity on goods and/or services to be sold by them, as well as a processor for processing such information documents, and subscribers' remote devices can display text, graphic, sound information, and include telephones and/or facsimile devices, personal computers with peripheral devices, which can reproduce and/or display the information documents or their parts, wherein it additionally contains advertising material carriers of subjects of business activity, information documents that are stored in the memory device, as this takes place, the advertising material carrier of a certain subject of business activity has information on unique number of the information document of such subject in the system assigned by the centralized server, and on the method of communication with the centralized server through the communication network, and users' remote devices can retrieve the information documents by the unique numbers, in so doing, users' telephones and/or facsimile devices can operate in a tone mode.

2. The system of claim 1 wherein advertising material carriers are made as magnetic carriers and/or paper mass media, and/or outdoor advertising and/or visiting cards, and/or booklets and/or advertising handbills.

3. The system of claim 1 wherein the peripheral device of a remote personal computer is made as light table, which has the capability to display an information document or its part in text or graphic form and is stationary or movably arranged on places of concentration of potential users of goods and/or services.

4. The system of claim 1 wherein the peripheral device of a remote personal computer is made as loudspeaker, which has the capability to reproduce an information document or its part in sound form and is stationary or movably arranged on places of concentration of potential users of goods and/or services.

5. The system of claim 1 wherein it is made with the capability to retrieve and select a required information document or its part by the user with the aid of a dial of the user's telephone and/or facsimile device operating in a tone mode, with the use of a certain order of dial-up of signals of a dial of the telephone and facsimile device by the user after establishing communication with the centralized server; as this takes place, the system additionally includes advertising material carriers of the system, which at the least have information on the method of communication with the centralized server through the telephone network and said order of dial-up of signals.

6. The system of claim 5 wherein it is made with the capability to reproduce a selected information document or its part with the aid of sound by sound reproduction device of the telephone and/or facsimile device.

7. The system of claim 5 wherein it is made with the capability to display a selected information document or its parts as image on the facsimile device's paper carrier.

8. The system of claim 5 wherein the order of dial-up of signals corresponds to the unique number of a subject's information document in the system.

9. The system of claim 5 wherein advertising material carriers of the system are made as magnetic carriers and/or paper mass media and/or carriers of outdoor advertising, and/or visiting cards and/or booklets and/or advertising handbills.

10. The system of claim 5 wherein it is made with the capability to reproduce the information document of a previously known subject or a part of such document with the aid of sound by sound reproduction device of the telephone and/or facsimile device within intervals when the user dials up signals of the dial.
